(19) United States
(12) Patent Application Publication
(10) Pub. No.: US 2018/0102108 A1
(43) Pub. Date: Apr. 12, 2018

(54) IMAGE PROCESSING APPARATUS AND IMAGE PROCESSING METHOD

(71) Applicant: MStar Semiconductor, Inc., Hsinchu Hsien (TW)

(72) Inventors: Chung-Yi Chen, Hsinchu Hsien (TW); Cheng-Liang Wang, Hsinchu Hsien (TW)

(21) Appl. No.: 15/596,111

(22) Filed: May 16, 2017

(30) Foreign Application Priority Data
Oct. 6, 2016 (TW) 105132377

(51) Int. Cl. G09G 5/10; G09G 3/20

(52) U.S. Cl. CPC G09G 5/10; G09G 3/2003; G09G 2320/0666; G09G 2320/0613; G09G 2320/0646; G09G 2360/16

(57) ABSTRACT

An image processing apparatus includes an analyzing circuit, a detecting circuit, a determining circuit, and a converting circuit. The analyzing circuit analyzes an image to obtain a default luminance of the image. The detecting circuit generates luminance distribution data of the image according to original luminance of a plurality of pixels in the image. The determining circuit determines a luminance converting relationship according to the default luminance of the image, the luminance distribution data of the image and a rated luminance of a display panel. The converting circuit generates converted luminance of the plurality of pixels according to the original luminance of the plurality of pixels of the image and the luminance converting relationship.

This application claims the benefit of Taiwan application Serial No. 105132377, filed Oct. 6, 2016, the subject matter of which is incorporated herein by reference.

### BACKGROUND OF THE INVENTION

### Field of the Invention

The invention relates to an image processing technology, and more particularly to a technology of adjusting image luminance.

### Description of the Related Art

A display panel usually has a maximum luminance it can present, and such luminance is referred to as a rated luminance. When an image is displayed by a display panel having a rated luminance that is the same as a default luminance of the image, an optimum viewing effect of the image is presented. However, when the rated luminance of the display panel differs from the default luminance of the image, the image cannot be displayed at its optimum viewing effect.

### SUMMARY OF THE INVENTION

The invention is directed to an image processing apparatus and an image processing method for solving the above issue.

An image processing apparatus is provided according to an embodiment of the present invention. The image processing apparatus includes an analyzing circuit, a detecting circuit, a determining circuit and a converting circuit. The analyzing circuit analyzes an image to obtain a default luminance of the image. The detecting circuit generates luminance distribution data of the image according to original luminance of a plurality of pixels in the image. The determining circuit determines a luminance converting relationship according to the default luminance of the image, the luminance distribution data of the image and a rated luminance of a display panel. The converting circuit generates converted luminance of the plurality of pixels of the image according to the original luminance of the plurality of pixels and the luminance converting relationship.

An image processing method is provided according to an embodiment of the present invention. In the image processing method, an image is analyzed to obtain a default luminance of the image. Luminance distribution data of the image is generated according to original luminance of a plurality of pixels of the image. A luminance converting relationship is determined according to the default luminance of the image, the luminance distribution data of the image and a rated luminance of a display panel. Converted luminance of the plurality of pixels of the image is generated according to the original luminance of the plurality of pixels of the image and the luminance converting relationship.

The above and other aspects of the invention will become better understood with regard to the following detailed description of the non-limiting embodiments. The following description is made with reference to the accompanying drawings.

### BRIEF DESCRIPTION OF THE DRAWINGS

FIG. 1 is a block diagram of an image processing apparatus according to an embodiment of the present invention;

FIG. 2(A) is a schematic diagram of an example of luminance distribution data of an image; FIG. 2(B) and FIG. 2(C) are schematic diagrams of luminance converting relationships determined according to the luminance distribution data in FIG. 2(A);

FIG. 3(A) is a schematic diagram of another example of luminance distribution data of an image; FIG. 3(B) and FIG. 3(C) are schematic diagrams of luminance converting relationships determined according to the luminance distribution data in FIG. 3(A);

FIG. 4(A) is a schematic diagram of an example of luminance distribution data of an image; FIG. 4(B) and FIG. 4(C) are schematic diagrams of luminance converting relationships determined according to the luminance distribution data in FIG. 4(A);

FIG. 5 is a block diagram of a converting circuit according to an embodiment of the present invention;

FIG. 6 is a block diagram of a converting circuit according to another embodiment of the present invention;

FIG. 7(A) is a block diagram of an image processing apparatus according to another embodiment of the present invention;

FIG. 7(B) is a block diagram of a compensating circuit according to an embodiment of the present invention; and

FIG. 8 is a flowchart of an image processing method according to an embodiment of the present invention.

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

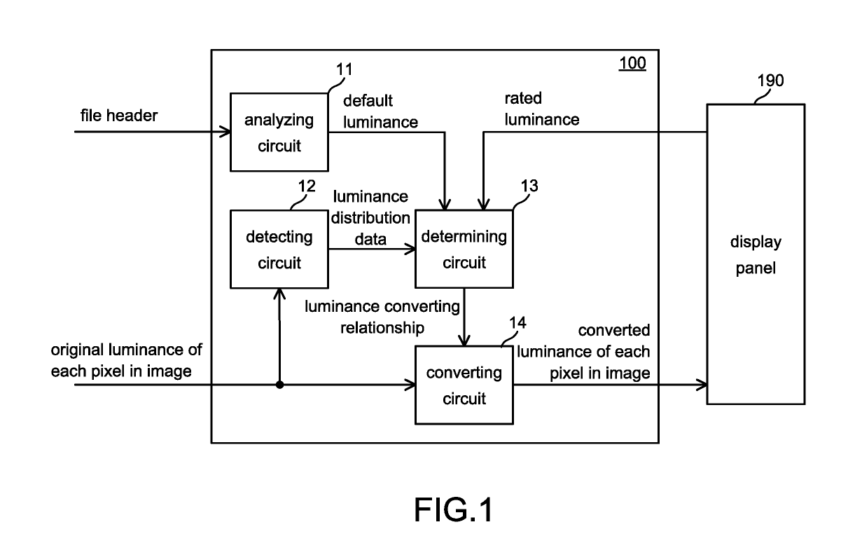

FIG. 1 shows a block diagram of an image processing apparatus 100 according to an embodiment of the present invention. The image processing apparatus 100, coupled to a display panel 190, includes an analyzing circuit 11, a detecting circuit 12, a determining circuit 13 and a converting circuit 14. In practice, the image processing apparatus 100 may be disposed in a television chip.

The analyzing circuit 11 analyzes an image to obtain a default luminance L_{I} of the image. In one embodiment, the analyzing circuit 11 obtains the default luminance L_{I} of the image by analyzing a file header of the image. The detecting circuit 12 generates luminance distribution data LDD_{I} according to an original luminance of multiple pixels of the image. It should be noted that, implementation details of the analyzing circuit 11 and the detecting circuit 12 are generally known to one person skilled in the art, and shall be omitted herein. The determining circuit 13 determines a luminance converting relationship LTR according to the default luminance L_{I} of the image, the luminance distribution data LDD_{I} of the image that is received from the analyzing circuit 11, and a rated luminance L_{D} of the display panel 190 (usually pre-recorded in a television chip coordinating with the display panel 190). The converting circuit 14 then generates a converted luminance of the multiple pixels of the image according to the original luminance of the multiple pixels of the image and the luminance converting relationship LTR.

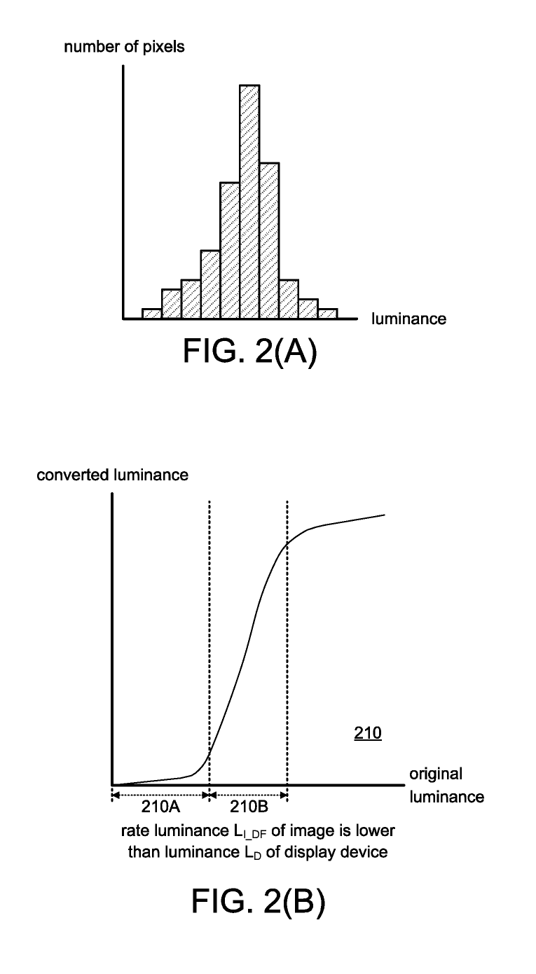

FIG. 2(A) shows a schematic diagram of an example of luminance distribution data of an image, wherein the horizontal axis represents the luminance and the vertical axis represents the number of pixels. Known from FIG. 2(A), the luminance of most of the pixels in the image is located in an intermediate luminance region, i.e., a luminance concentrated area of the image is in an intermediate luminance region. FIG. 2(B) shows a schematic diagram of an example of a luminance converting relationship that is determined by the determining circuit 13 according to the luminance distribution data in FIG. 2(A) when the rated luminance of a display panel is higher than the default luminance of the image. FIG. 2(C) shows a schematic diagram of an example of a luminance converting relationship that is determined by the determining circuit 13 according to the luminance distribution data in FIG. 2(A) when the rated luminance of a display panel is lower than the default luminance of the image. In the diagrams, the horizontal axis represents the original luminance, and the vertical axis represents the converted luminance. Because the luminance of most of the pixels in the image is located in an intermediate luminance region, the segment with a highest slope in a curve 210 in FIG. 2(B) and the segment with a highest slope in a curve 220 in FIG. 2(C) correspond to respective intermediate luminance regions 210B and 220B. Thus, the evenness in the luminance of the image can be enhanced to achieve an effect of increasing the contrast.

Further, for the luminance of the pixels, to maintain the consistency in the luminance presented by display panels having different rated luminances, compared to the curve 210 corresponding to the rated luminance L_{D} of the display panel that is higher than the default luminance L_{I} of the image, the slope of the curve 220 corresponding to the rated luminance L_{D} of the display panel that is lower than the default luminance L_{I} of the image is greater. For example, the slope of the curve 220 in a low luminance region 220A is greater than the slope of the curve 210 in a low luminance region 210A.

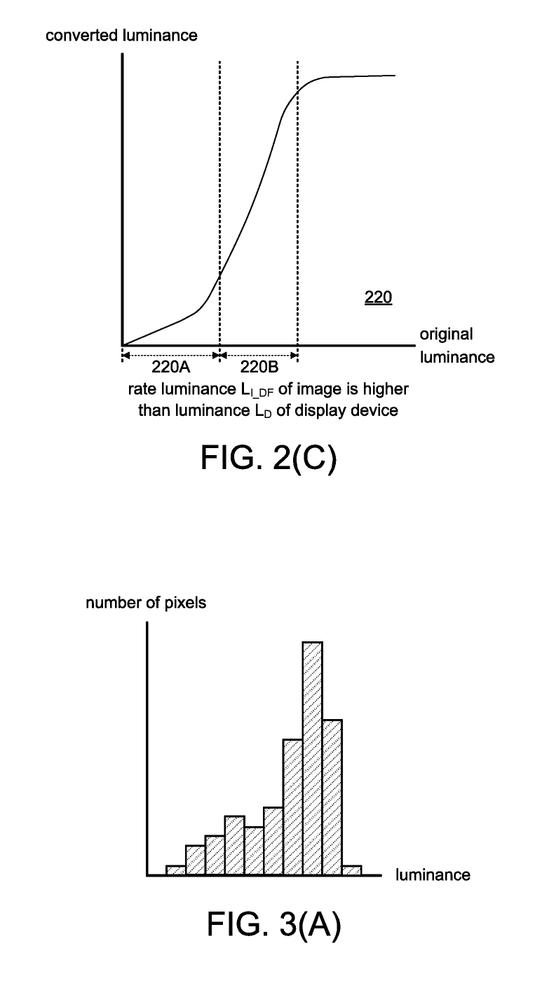

FIG. 3(A) shows a schematic diagram of an example of luminance distribution data of an image, where the horizontal axis represents the luminance and the vertical axis represents the number of pixels. Known from FIG. 3(A), the luminance of most of the pixels in the image is located in a high luminance region; that is, the luminance concentrated area of the image is located in a high luminance region. FIG. 3(B) shows a schematic diagram of an example of a luminance converting relationship that is determined by the determining circuit 13 according to the luminance distribution data in FIG. 3(A) when the rated luminance of a display panel is higher than the default luminance of the image. FIG. 3(C) shows a schematic diagram of an example of a luminance converting relationship that is determined by the determining circuit 13 according to the luminance distribution data in FIG. 3(A) when the rated luminance of a display panel is lower than the default luminance of the image. In the diagrams, the horizontal axis represents the original luminance, and the vertical axis represents the converted luminance. Because the luminance of most of the pixels in the image is located in a high luminance region, the segment with a highest slope in a curve 310 in FIG. 3(B) and the segment with a highest slope in a curve 320 in FIG. 3(C) correspond to respective high luminance regions 310B and 320B. Thus, the evenness in the luminance of the image can be enhanced to achieve an effect of increasing the contrast.

Further, for the luminance of the pixels, to maintain the consistency in the luminance presented by display panels having different rated luminances, compared to the curve 310 corresponding to the rated luminance L_{D} of the display panel that is higher than the default luminance L_{I} of the image, the slope of the curve 320 corresponding to the rated luminance L_{D} of the display panel that is lower than the default luminance L_{I} of the image is greater. For example, the slope of the curve 320 in a low luminance region 320A is greater than the slope of the curve 310 in a low luminance region 310A.

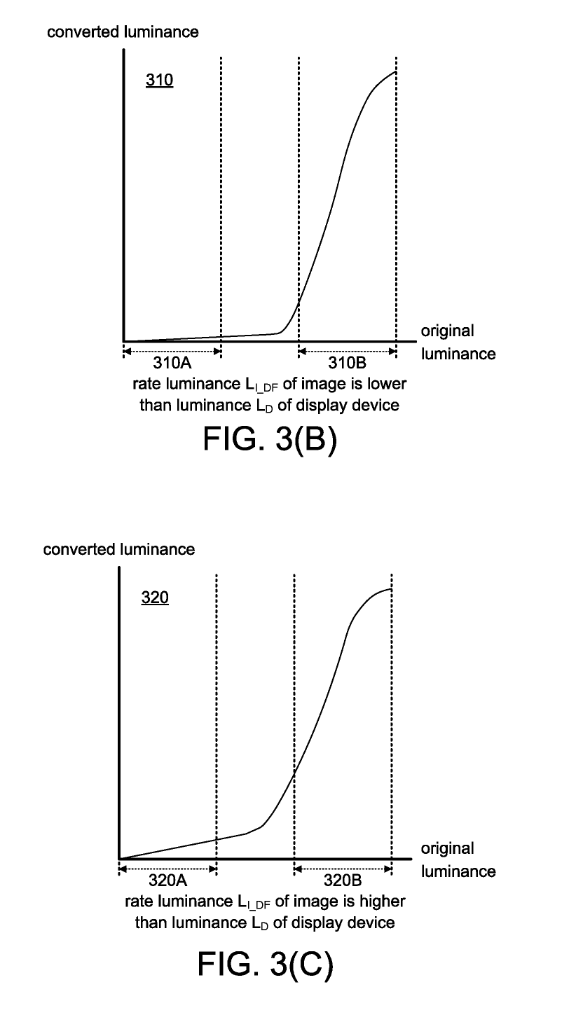

FIG. 4(A) shows a schematic diagram of an example of luminance distribution data of an image, where the horizontal axis represents the luminance and the vertical axis represents the number of pixels. Known from FIG. 4(A), the luminance of most of the pixels in the image is located in a low luminance region; that is, the luminance concentrated area of the image is located in a low luminance region. FIG. 4(B) shows a schematic diagram of an example of a luminance converting relationship that is determined by the determining circuit 13 according to the luminance distribution data in FIG. 4(A) when the rated luminance of a display panel is higher than the default luminance of the image. FIG. 4(C) shows a schematic diagram of an example of a luminance converting relationship that is determined by the determining circuit 13 according to the luminance distribution data in FIG. 4(A) when the rated luminance of a display panel is lower than the default luminance of the image. In the diagrams, the horizontal axis represents the original luminance, and the vertical axis represents the converted luminance. Because the luminance of most of the pixels in the image is located in a low luminance region, the segment with a highest slope in a curve 410 in FIG. 4(B) and the segment with a highest slope in a curve 420 in FIG. 4(C) correspond to respective low luminance regions 410A and 420A. Thus, the evenness in the luminance of the image can be enhanced to achieve an effect of increasing the contrast.

Further, for the luminance of the pixels, to maintain the consistency in the luminance presented by display panels having different rated luminances, compared to the curve 410 corresponding to the rated luminance L_{D} of the display panel that is higher than the default luminance L_{I} of the image, the slope of the curve 420 corresponding to the rated luminance L_{D} of the display panel that is lower than the default luminance L_{I} of the image is greater. For example, the slope of the curve 420 in a low luminance region 420A is greater than the slope of the curve 410 in a low luminance region 410A.

From another perspective, when the rated luminance L_{D} of the display panel is higher than the default luminance L_{I} of the image, it is seen from the luminance converting relationships determined by the determining circuit 13 in FIG. 2, FIG. 3 and FIG. 4 that, high slope intervals in the curves correspond to respective luminance concentrated areas. For example, the luminance corresponding to a high slope interval of the curve 210 which corresponds to an image having a luminance concentrated area located in the intermediate luminance region, is lower than the luminance corresponding to a high slope interval of the curve 310 which corresponds to an image having a luminance concentrated area located in the high luminance region, but higher than the luminance corresponding to a high slope interval of the curve 410 which corresponds to an image having a luminance concentrated area located in the low luminance region.

In conclusion, the determining circuit 13 may determine a luminance converting relationship LTR according to the luminance distribution data of the image, and a relative relationship of the default luminance L_{I} of the image and the rated luminance L_{D} of the display panel. It should be noted that, the foregoing examples are for illustrating the strategy that the determining circuit 13 uses to determine the luminance converting relationship LTR under different circumstances. Further, the slopes of the intervals are not limited to specific values, and the so-called low luminance region is not limited to a specific range—these may be selected by a circuit designer based on the rule of thumb.

In practice, the determining circuit 13 may be realized by different types of control and processing platforms, including fixed and programmable logic circuits, e.g., a programmable logic gate array, an integrated circuit, a microcontroller, a microprocessor, and a digital signal processor (DSP). Further, the controller may be designed to complete associated tasks through executing instructions stored in a memory (not shown).

In one embodiment, the determining circuit 13 utilizes one or multiple functions to describe the luminance converting relationship, and provides the function(s) to the converting circuit 14. Accordingly, the converting circuit 14 is capable of using an original luminance of the pixels in the image as an input value of the function(s) to calculate a converted luminance. In practice, the converting circuit 14 may be realized by multiple operation circuits (e.g., an addition/subtraction/multiplication/division circuit, a trigonometry operation circuit and an exponential logarithm operation circuit) or a microprocessor.

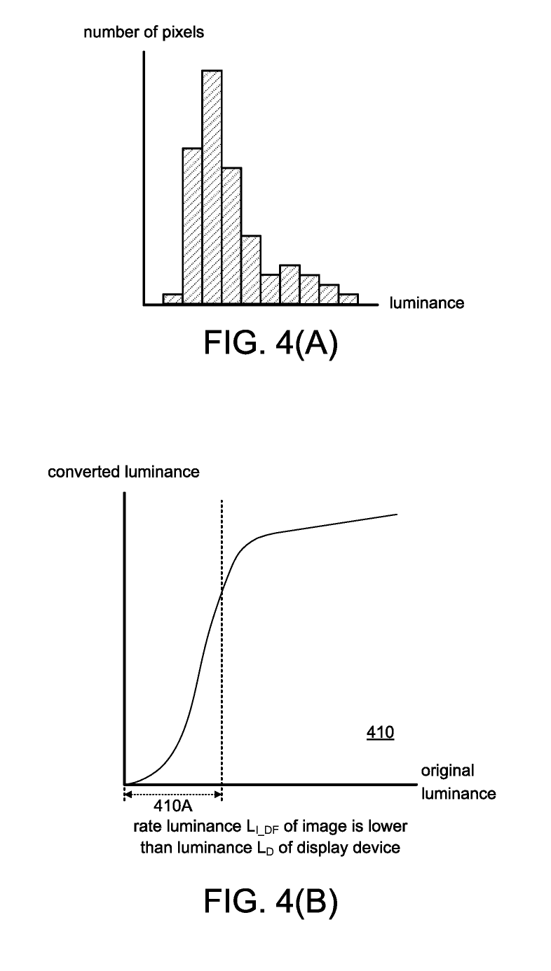

FIG. 5 shows a block diagram of the converting circuit 14 according to an embodiment of the present invention. In this embodiment, the converting circuit 14 includes a storage circuit 14A and a look-up circuit 14B. The storage circuit 14A stores a look-up table (LUT), which is provided by the determining circuit 13 and includes a plurality of parameters representing a luminance converting relationship. More specifically, each set of parameters includes an input luminance and an output luminance to present the luminance converting relationship. Taking an example of representing the input luminance by an 8-bit byte, 256 different values are possible. Thus, the determining circuit 13 may provide 256 sets of parameters respectively corresponding to 256 converting relationships of the input luminances and the output luminances. The look-up circuit 14B then outputs a converted luminance according to the original luminance of the pixels in the image and the LUT. An advantages of realizing the converting circuit 14 by an LUT is that, many operation circuits can be eliminated to reduce hardware costs.

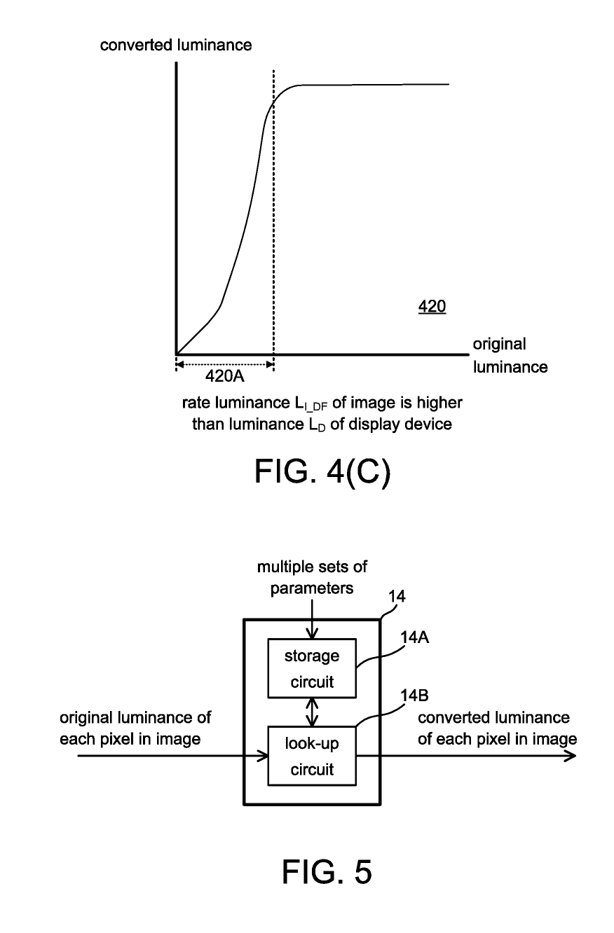

FIG. 6 shows a block diagram of the converting circuit 14 according to another embodiment of the present invention. In this embodiment, the converting circuit 14 includes a storage circuit 14C, a look-up circuit 14D and an interpolating circuit 14E. Similarly, the storage circuit 14C stores an LUT provided by the determining circuit 13. However, in this embodiment, the LUT includes only 32 sets of parameters, which are apparently less than 256 values of the input luminance to reduce a memory space that the LUT occupies in the storage circuit 14C. Taking an example of representing the input luminance by an 8-bit byte, these 32 sets of parameters may correspond to 32 input luminances with 3 least significant bits all being zero, including 00000000, 00001000, 00010000, 00011000, 00100000, 00101000 . . . . According to 5 most significant bits of the original luminance of a pixel, the look-up circuit 14D may identify two input luminances closest to the original luminance from the LUT, and then identify the two output luminances respectively corresponding to the two input luminances. The two output luminances are then interpolated to generate the converted luminance of the pixel.

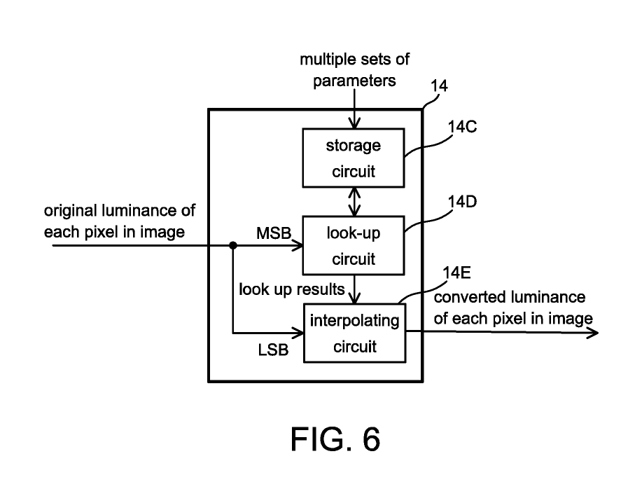

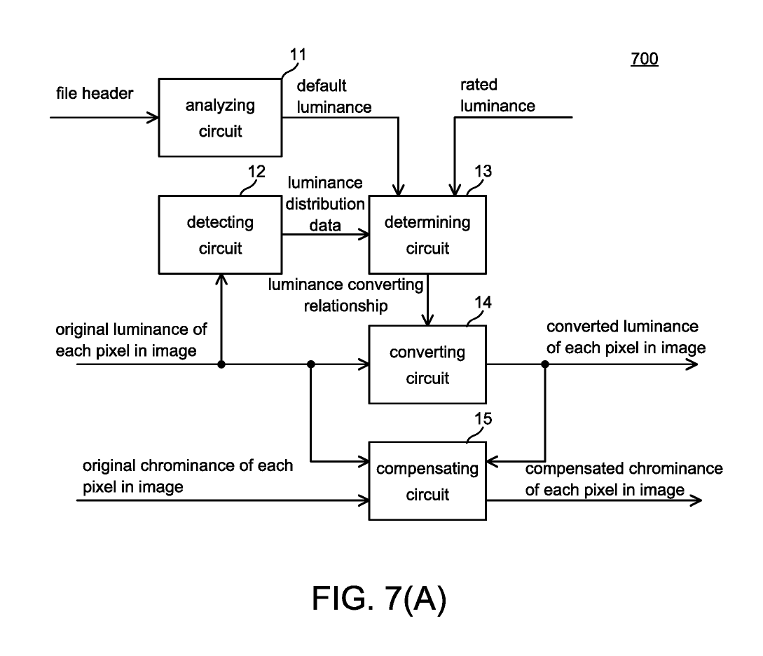

For the YUV color space and the YCbCr color space, the change in luminance changes the visual saturation, and so the saturation needs to be compensated. FIG. 7(A) shows a block diagram of an image processing apparatus 700 according to another embodiment of the present invention. Compared to the image processing apparatus 100 in FIG. 1, the image processing apparatus 700 further includes a compensating circuit 15, which compensates the influence on the saturation as a result of the converting circuit 14 adjusting the luminance. More specifically, the compensating circuit 14 adjusts the chrominance of a pixel according to the original luminance of the pixels and the converted luminance of the pixel that the converting circuit 14 outputs, so as to maintain substantially the same visual saturation for the pixel.

FIG. 7(B) shows a block diagram of a compensating circuit 15 according to an embodiment of the present invention. In this embodiment, the compensating circuit 15 includes a reciprocal circuit 15A, a first multiplier 15B and a second multiplier 15C. The reciprocal circuit 15A outputs a reciprocal of an original luminance according to the original luminance. In practice, an LUT may be used to realize the reciprocal circuit 15A. The first multiplier 15B multiplies the reciprocal of the original luminance by the converted luminance, which is equivalently dividing the converted luminance by the original luminance, to generate a ratio of the converted luminance to the original luminance. The second multiplier 15C then multiplies an original chrominance by the ratio to generate an adjusted chrominance to maintain the visual saturation substantially unchanged. In practice, the original luminance provided to the reciprocal circuit 14A and the converted luminance provided to the first multiplier 15B may be standardized to values between 0 and 1.

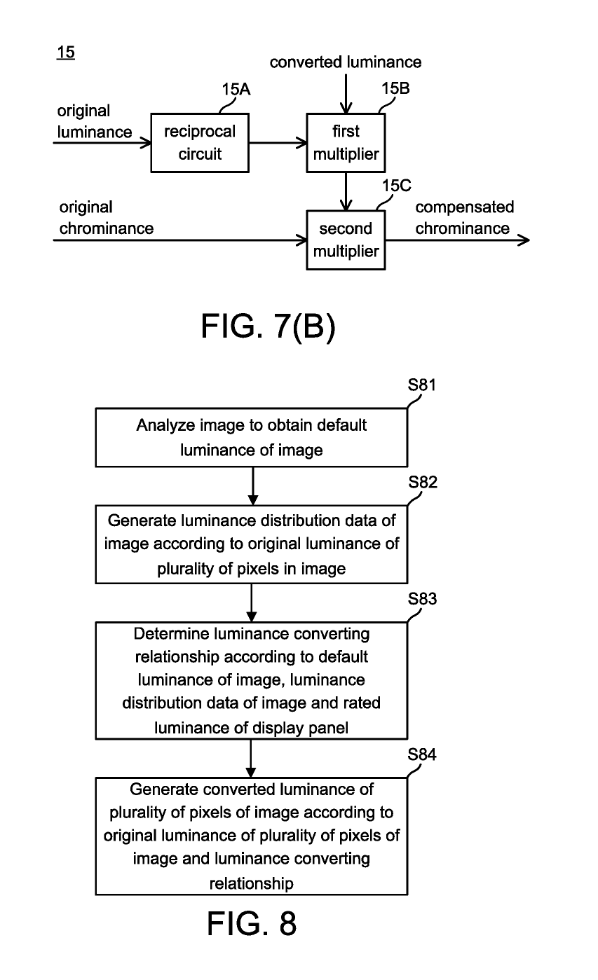

FIG. 8 shows a flowchart of an image processing method according to an embodiment of the present invention. In step S81, an image is analyzed to obtain a default luminance of the image. In step S82, luminance distribution data of the image is generated according to an original luminance of multiple pixels in the image. In step S83, a luminance converting relationship is determine according to the default luminance of the image, the luminance distribution data of the image and a rated luminance of a display panel. In step S84, a converted luminance of the multiple pixels is generated according to the original luminance of the multiple pixels and the luminance converting relationship.

One person skilled in the art can understand that, operation variations in the description associated with the image processing apparatus 100 are applicable to the image processing method in FIG. 8, and shall be omitted herein.

While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
an analyzing circuit, analyzing an image to obtain a default luminance of the image;
a detecting circuit, generating luminance distribution data according to original luminance of a plurality of pixels in the image;
a determining circuit, determining a luminance converting relationship according to the default luminance of the image, the luminance distribution data of the image and a rated luminance of a display panel; and
a converting circuit, generating converted luminance of the plurality pixels in the image according to the original luminance of the plurality of pixels and the luminance converting relationship.

2. The image processing apparatus according to claim 1, wherein:
when the rated luminance of the display panel is higher than the default luminance of the image, and a luminance concentrated area of the luminance distribution data of the image is located in a low luminance region, the luminance converting relationship is a first luminance converting relationship;
when the rated luminance of the display panel is higher than the default luminance of the image, and the luminance concentrated area of the luminance distribution data of the image is located in a high luminance region, the luminance converting relationship is a second luminance converting relationship; and
when the luminance converting relationship is expressed by a horizontal axis representing the original luminance and a vertical axis representing the converted luminance, a luminance corresponding to a high slope interval in the second luminance converting relationship is higher than a luminance corresponding to a high slope interval in the first luminance converting relationship.

3. The image processing apparatus according to claim 1, wherein:
when the rated luminance of the display panel is higher than the default luminance of the image, and a luminance concentrated area of the luminance distribution data of the image is located in an intermediate luminance region, the luminance converting relationship is a third luminance converting relationship;
when the rated luminance of the display panel is lower than the default luminance of the image, and a luminance concentrated area of the luminance distribution data of the image is located in the intermediate luminance region, the luminance converting relationship is a fourth luminance converting relationship; and
when the luminance converting relationship is expressed by a horizontal axis representing the original luminance and a vertical axis representing the converted luminance, a curve slope corresponding to a low luminance region in the third luminance converting relationship is smaller than a curve slope corresponding to a low luminance region in the fourth luminance converting relationship.

4. The image processing apparatus according to claim 1, wherein the converting circuit comprises:
a storage circuit, storing a look-up table (LUT), which comprises a plurality of sets of parameters representing the luminance converting relationship; and
a look-up circuit, outputting a converted luminance of at least one pixel in the image according to an original luminance of the at least one pixel and the LUT.

5. The image processing apparatus according to claim 1, wherein the converting circuit comprises:
a storage circuit, storing a look-up table (LUT), which comprises a plurality of sets of parameters representing the luminance converting relationship; and
a look-up circuit, identifying two corresponding output luminances according to a part of bits of an original luminance of at least one pixel in the image and the LUT; and
an interpolating circuit, performing an interpolation calculation on the two output luminances according to the original luminance to generate a converted luminance of the at least one pixel.

6. The image processing apparatus according to claim 1, further comprising:
a compensating circuit, adjusting an original chrominance of at least one pixel in the image according to an original luminance of the at least one pixel and a converted luminance of the at least one pixel.

7. The image processing apparatus according to claim 6, wherein the compensating circuit adjusts the original chrominance of the at least one pixel according to a ratio of the converted luminance to the original luminance of the at least one pixel.

8. An image processing method, comprising:
a) analyzing an image to obtain a default luminance of the image;
b) generating luminance distribution data according to original luminance of a plurality of pixels in the image;
c) determining a luminance converting relationship according to the default luminance of the image, the luminance distribution data of the image and a rated luminance of a display panel; and
d) generating converted luminance of the plurality pixels in the image according to the original luminance of the plurality of pixels and the luminance converting relationship.

9. The image processing method according to claim 8, wherein step (c) comprises:
when the rated luminance of the display panel is higher than the default luminance of the image, and a luminance concentrated area of the luminance distribution data of the image is located in a low luminance region, causing the luminance converting relationship to be a first luminance converting relationship; and
when the rated luminance of the display panel is higher than the default luminance of the image, and the luminance concentrated area of the luminance distribution data of the image is located in a high luminance region, causing the luminance converting relationship to be a second luminance converting relationship;
wherein, when the luminance converting relationship is expressed by a horizontal axis representing the original luminance and a vertical axis representing the converted luminance, a luminance corresponding to a high slope interval in the second luminance converting relationship is higher than a luminance corresponding to a high slope interval in the first luminance converting relationship.

10. The image processing method according to claim 8, wherein step (c) comprises:
when the rated luminance of the display panel is higher than the default luminance of the image, and a luminance concentrated area of the luminance distribution data of the image is located in an intermediate luminance region, causing the luminance converting relationship to be a third luminance converting relationship;
when the rated luminance of the display panel is lower than the default luminance of the image, and a luminance concentrated area of the luminance distribution data of the image is located in the intermediate luminance region, causing the luminance converting relationship to be a fourth luminance converting relationship; and
when the luminance converting relationship is expressed by a horizontal axis representing the original luminance and a vertical axis representing the converted luminance, a curve slope corresponding to a low luminance region in the third luminance converting relationship is smaller than a curve slope corresponding to a low luminance region in the fourth luminance converting relationship.

11. The image processing method according to claim 8, wherein the luminance converting relationship comprises a plurality of sets of parameters forming a look-up table (LUT), and step (d) comprises:
outputting a converted luminance of at least one pixel in the image according to an original luminance of the at least one pixel and the LUT.

12. The image processing method according to claim 8, wherein the luminance converting relationship comprises a plurality of sets of parameters forming a look-up table (LUT), and step (d) comprises:
identifying two corresponding output luminances according to a part of bits of an original luminance of at least one pixel in the image and the LUT; and
performing an interpolation calculation on the two output luminances according to the original luminance to generate a converted luminance of the at least one pixel.

13. The image processing method according to claim 8, further comprising:
e) adjusting an original chrominance of at least one pixel in the image according to an original luminance of the at least one pixel and a converted luminance of the at least one pixel.

14. The image processing method according to claim 13, wherein step (e) comprises:
adjusting the original chrominance of the at least one pixel according to a ratio of the converted luminance to the original luminance of the at least one pixel.
